(19) United States
(12) Patent Application Publication
(10) Pub. No.: US 2007/0264026 A1
(43) Pub. Date: Nov. 15, 2007

(54) Method and apparatus for controlling phase of a clock signal

(76) Inventor: Joseph D. Miguel, Petaluma, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/500,179

(22) Filed: Aug. 7, 2006

Related U.S. Application Data
(60) Provisional application No. 60/799,427, filed on May 10, 2006.

(51) Int. Cl. H04B 10/00

(52) U.S. Cl. 398/155

(57) ABSTRACT

A method and corresponding apparatus are disclosed for controlling the phase of a second clock signal from (i) a first clock signal of different frequency and (ii) a synchronization signal. One example embodiment recovers a first clock signal from a bus carrying data and detects a synchronization signal. Both the first clock signal and the synchronization signal are provided to a clock generator, which then generates the second clock signal with a phased based on the first clock signal and the synchronization signal. The use of the example embodiment is a low cost way to easily control the phase of a second clock signal with minimal added components and/or additional signal processing.

### RELATED APPLICATION(S)

This application claims the benefit of U.S. Provisional Application No. 60/799,427, filed on May 10, 2006. The entire teachings of the above application(s) are incorporated herein by reference.

### BACKGROUND OF THE INVENTION

The present invention relates to the generation of upstream clocks in optical networks and in particular, to a method and apparatus for generating an upstream clock of known phase from a downstream clock of different frequency. When an upstream clock is generated using a downstream clock of different frequency (also referred to as being “asymmetric upstream and downstream clocks”), multiple phase relationships between the two clocks are possible. For example, FIG. 1 illustrates timing diagrams of a downstream clock (DS_CLK) having a frequency of 622.08 Mbps, and four possible upstream clocks (00, 01, 02, and 03) each having a frequency of 155.52 Mbps, wherein each of the four possible upstream clocks may have been generated from the downstream clock, but with a different phase relationship. Such multiplicity of phase relationships, however, adds variability and uncertainty that must be accommodated by various signal processing mechanisms.

### SUMMARY OF THE INVENTION

Accordingly, a method and corresponding apparatus for controlling the phase of a second clock signal based on a first clock signal and a synchronization signal is provided. The method or corresponding apparatus is easy to implement with minimal added components and/or additional signal processing to an existing system and is of low cost, in accordance with an embodiment of the present invention. An example embodiment includes: recovering a first clock signal from a bus carrying data; detecting the synchronization signal, providing the first clock signal and the synchronization signal to a clock generator, and generating the second clock signal with a phase based on the first clock signal and the synchronization signal.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a timing diagram illustrating a downstream clock signal and several upstream clock signals of differing phases conventionally generated from downstream clock signal;

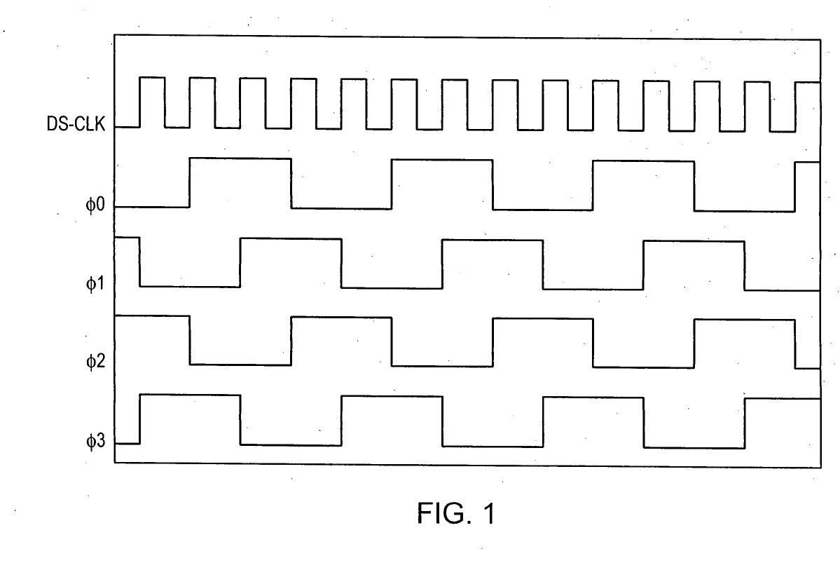

FIG. 2 is a block diagram illustrating a passive optical network including an optical network terminal utilizing aspects of the present invention;

FIG. 3 is a flow diagram illustrating a method for controlling a phase of a clock signal;

FIG. 4 is a flow diagram illustrating a method for generating a second clock signal from a first clock signal;

FIG. 5 is a flow diagram illustrating a method for controlling a phase of a clock signal using a variable bit delay;

FIG. 6 is a block diagram illustrating an apparatus for controlling a phase of a clock signal;

FIG. 7 is a timing diagram illustrating a first clock, synchronization signal, and second clock generated according to a method and/or apparatus utilizing aspects of an example embodiment of the present invention;

FIG. 8 is a block diagram illustrating an apparatus for controlling a phase of a clock signal using a shift register.

### DETAILED DESCRIPTION OF THE INVENTION

A description of example embodiments of the invention follows.

The more generalized terms of “first data,” “first clock,” “second data,” and “second clock” are used herein to accommodate situations where the data streams and clock signals may not be transmitted via data in a per se downstream or upstream direction between network nodes. For example the network notes may be peers, so the terms “upstream” and “downstream” do not apply per se. Further certain embodiments may be employed in inter- or intra-chip communications.

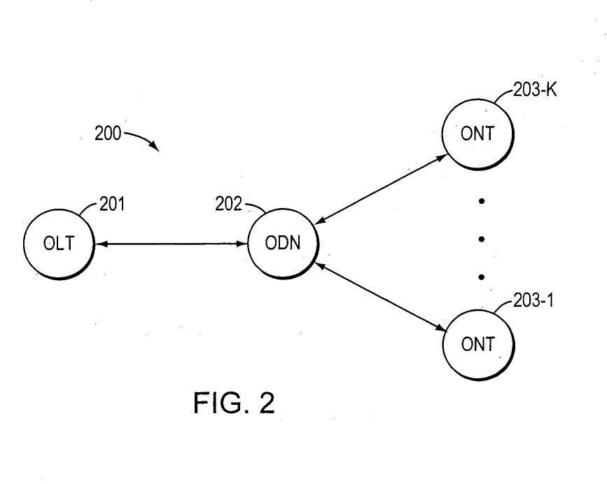

FIG. 2 illustrates, as an example, a block diagram of a passive optical network (PON) 200 including an optical line terminal (OLT) 201 located in a central office, an optical distribution network (ODN) 202 including optical fibers and passive optical splitters or couplers, and at least one optical network terminal (ONT) or optical network unit (ONU) (hereinafter both referred to as being an ONT) 203-1 to 203-K utilizing aspects of the present invention.

Communication of data transmitted by the OLT 201 to the ONTs 203-1 to 203-K is performed in a conventional point-to-multipoint fashion (e.g., broadcast with IDs of intended recipients). In contrast, communication of data transmitted by individual ones of the ONTs 203-1 to 203-K back to the OLT 201 is performed in a conventional point-to-point fashion (e.g., using TDMA time slotting to avoid collisions).

In certain PON configurations, a first clock frequency, which is the rate that data from the OLT is received at each of the ONTs, is greater than, such as an integer multiple of, a second clock frequency, which is the rate that data may be transmitted back to the OLT by each of the ONTs. For example, in a broadband PON (BPON), data rates of 622.08 Mbps from the OLT to the ONTs and data rates of 155.52 Mbps from the ONTs to the OLT are common.

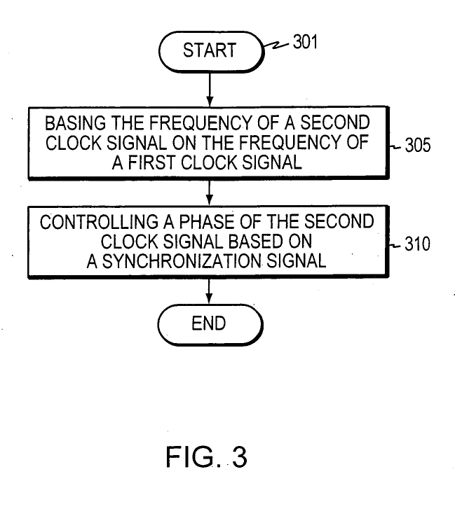

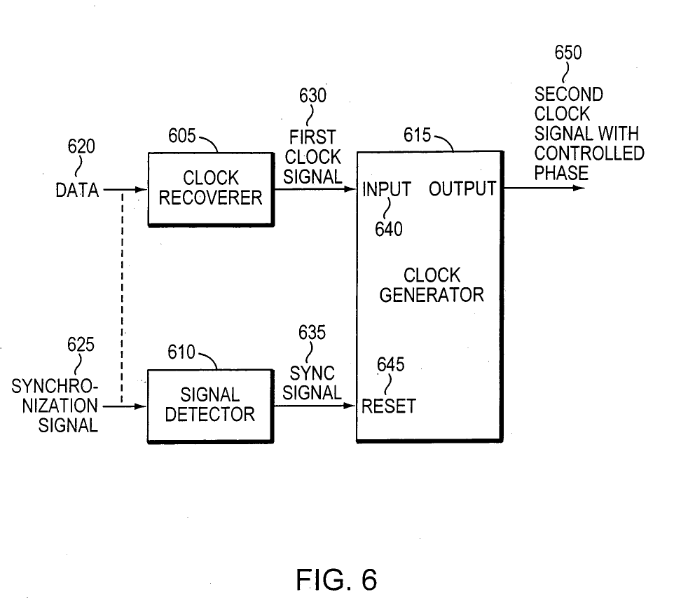

To accommodate such different data rate situations, the ONTs 203-1 to 203-K perform the method described, for example, in reference to FIG. 3 and/or otherwise include an apparatus as described, for example, in reference to FIG. 6 to control the phase of a clock signal.

FIG. 3 is a flow diagram illustrating a basic method for controlling a phase of a clock signal according to an embodiment of the invention. The frequency of a second clock signal is based on the frequency of a first clock signal (305). The phase of the second clock is then controlled based on a synchronization signal used for synchronizing communications in the second direction (310). The synchronization signal can come from data sent by the OLT or can represent an event not embedded in such data. If the synchronization signal comes from the data sent by the OLT, it can be a start-of-frame (SOF) indicator and can include detecting the SOF for each frame indicator included in the data.

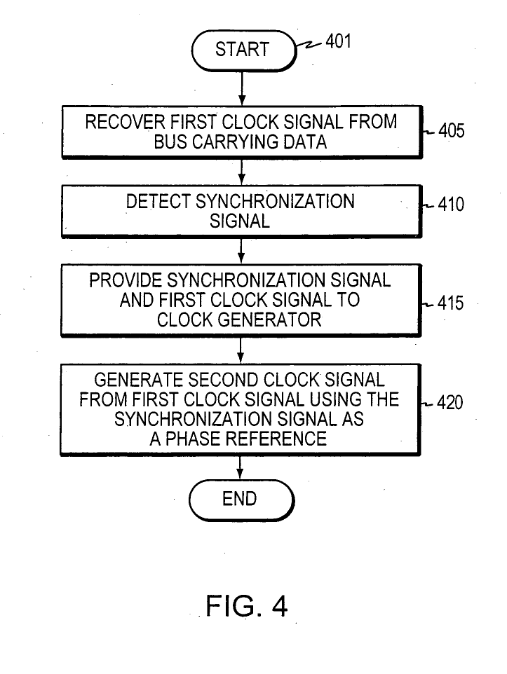

FIG. 4 is a flow diagram illustrating a method for generating a second clock signal from a first clock signal. A first clock signal is recovered from a bus carrying data from an OLT (405), and a synchronization signal is detected (410). The first clock signal and synchronization signal are provided to a reset or clear-input pin of a clock generator (415), which generates a second clock signal with a phase based on the first clock signal and the synchronization signal (420). The second clock signal may then be used as a TX clock for transmitting data from the ONT back to the OLT. This data may include ATM cells and/or Ethernet frame units, and it may use a TDMA protocol in transmitting the data from the ONT to the OLT, or any other data construct or transmission protocol used in any conventional PON network, such as used in APON, BPON, GPON or EPON, where an APON is an ATM PON, GPON is a Gigabit PON, and EPON is an Ethernet PON.

Optionally, generating the second clock signal can include dividing the frequency of the first clock signal by an integer N and, optionally, the clock generator can be a modulo N counter. Additionally, the frequency of the first clock can be higher than the frequency of the second clock.

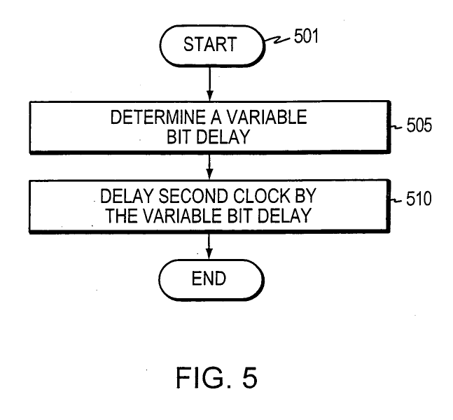

FIG. 5 is a flow diagram illustrating an additional method for controlling a phase of a clock signal using a variable bit delay. Where the first clock signal is frequency locked, a variable bit delay of a second clock signal relative to a first clock signal can be determined (505). The second clock signal can then be delayed by the variable bit delay (510), thus controlling the phase of the second clock signal relative to the first clock signal. The variable bit delay can be determined multiple ways, including sampling the second clock signal at the frequency of the first clock signal or measuring a difference between the frequencies of the first and second clock signals. Optionally, the frequency of the second clock signal can be a non-integer multiple of the frequency of the first clock signal. As another example, the rate at which data packet are received (e.g., every 500 μsec) may not define a network clock rate based on which the second clock signal is to be generated or synthesized. Using the rate of packet receipt, the phase of a second clock signal can also be controlled in accordance with embodiments of the present invention.

FIGS. 3-5 are flow diagrams illustrating methods according to embodiments of the present invention. The techniques illustrated in these figures may be performed sequentially, in parallel, or in an order other than that which is described. It should be appreciated that not all of the techniques described are required to be performed, that additional techniques may be added, and that some of the illustrated techniques may be substituted with other techniques.

FIG. 6 is a block diagram illustrating an apparatus included in one or more ONTs in a PON for controlling a phase of a clock signal. Data 620 received from an OLT is coupled or otherwise made available, in whole or in part, to a clock recoverer 605. The clock recoverer 605 recovers a first clock signal 630 from the data 620, and provides the first clock signal 630 to an input 640 of clock generator 615. A synchronization signal used for synchronizing communications is optionally embedded in the data 620 from the OLT, such as the SOF indicator, or represents an event not embedded in such data. The synchronization signal 625 used for synchronizing communications is made available to signal detector 610, which detects the synchronization signal 625 and provides it to the reset or clear-input pin of the clock generator 615, optionally in a processed form 635, such as jitter controlled. The clock generator 615 then generates a second clock signal 650 from the first clock signal 630, where the phase of the second clock signal 650 is controlled as a function of the synchronization signal 625, 635.

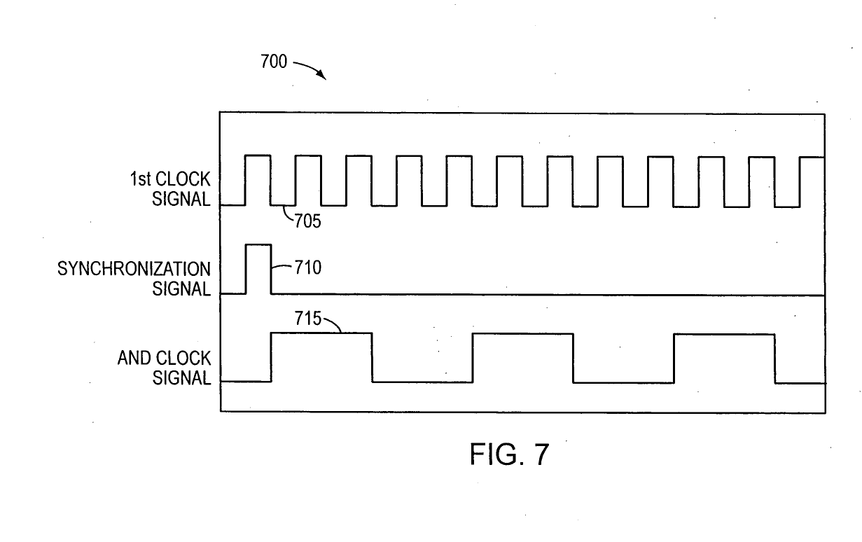

Optionally, the clock generator 615 can be a frequency divider circuit that generates the second clock 650 signal at a frequency equal to the frequency of the first clock signal 630 divided by an integer N, using the synchronization signal 625, 635 to reset the generation so as to serve as a phase reference. FIG. 7, for example, is a timing diagram 700 illustrating the generation of a second clock signal 715 from a first clock signal 705 using a synchronization signal 710 as a phase reference for an integer value of four (4) for the frequency divider circuit.

One example of such a frequency divider is a modulo N counter. In that case, the first clock signal is provided to an input of the modulo N counter, and the synchronization signal is provided to a reset or clear input of the modulo N counter, so that the second clock signal is provided at an output of the modulo N counter at a frequency equal to the frequency of the first clock signal divided by the integer N.

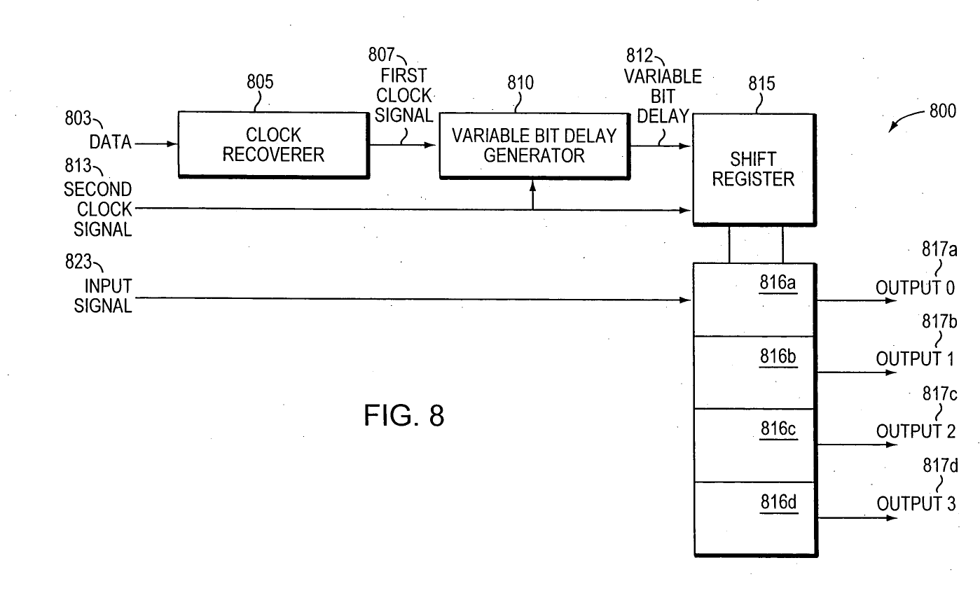

FIG. 8 is a block diagram illustrating another apparatus 800 included in one or more ONTs in a PON for controlling a phase of a clock signal, in which the apparatus uses a shift register to control the phase of the clock signal. Data 803 received from an OLT is coupled or otherwise made available, in whole or in part, to a clock recoverer 805. The clock recoverer 805 recovers a first clock signal 807 from the data 803, the frequency of the first clock signal 807 being frequency locked. The first clock signal 807 along with a second clock signal 813 is provided to variable bit delay generator 810, which calculates a variable bit delay 812 of the second clock signal 813 relative to the first clock signal 807. The variable bit delay 812, second clock signal 813, and an input signal 823 are provided to a shift register 815 with cells 816a-816d. The output 817a-817d of the shift register 815 is the second clock 813 signal and corresponding input signal 823 delayed by 0, 1, 2, or 3 edges (rising or falling) of the first clock signal 807.

Optionally, the variable bit delay generator 810 can sample the second clock signal 813 at the frequency first clock signal 807 to determine the variable bit delay 812. In another embodiment, the variable bit delay generator 810 can measure a difference between the frequency of the second clock signal 813 and the frequency of the first clock signal 807 and calculate the variable bit delay 812. In another embodiment, the input signal 823 is the same as the data 803.

In the foregoing description, the invention is described with reference to specific example embodiments thereof. The specification and drawings are accordingly to be regarded in an illustrative rather than in a restrictive sense. It will, however, be evident that various modifications and changes may be made thereto, in a computer program product or software, hardware or any combination thereof, without departing from the broader spirit and scope of the present invention.

Software embodiments of the present invention may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processor system causes the processor to perform an action to produce a result.

While this invention has been particularly shown and described with references to examples embodiments thereof, it will be understood by those skilled in the art that various changes in form and details may be made therein without departing from the scope of the invention encompassed by the appended claims.

What is claimed is:

1. A method of controlling phase of a clock signal, comprising:
basing a frequency of a second clock signal in a second direction on a frequency of a first clock signal in a first direction; and
controlling a phase of the second clock signal based on a synchronization signal used for synchronizing communications in the second direction.

2. The method according to claim 1, wherein controlling the phase of the second clock signal includes detecting a start-of-frame indicator from a signal carrying data in the first direction.

3. The method according to claim 2, wherein detecting the start-of-frame comprises detecting a start-of-frame for each frame indicator included in the data.

4. The method according to claim 1, wherein the phase of the second clock signal is based on a signal representing an event not embedded in a data in the first direction.

5. The method according to claim 1, wherein the first clock signal is a downstream clock signal and the second clock signal is an upstream clock signal.

6. The method according to claim 1, further including generating the second clock signal comprising:
recovering the first clock signal from a bus carrying data;
detecting the synchronization signal;
providing the first clock signal and the synchronization signal to a clock generator; and
generating the second clock signal with a phased based on the first clock signal and the synchronization signal.

7. The method according to claim 6, wherein the first clock signal has a first clock frequency and generating the second clock signal includes dividing the frequency of the first clock signal by an integer N.

8. The method according to claim 7, wherein the clock generator is a modulo N counter.

9. The method according to claim 8, wherein the first clock frequency is higher than the second clock frequency.

10. An apparatus for controlling a phase of a clock signal, comprising:
a clock recoverer including an input coupled to a bus carrying data and an output providing a first clock signal recovered from the data;
a signal detector including an output providing a synchronization signal detected for use in synchronizing communications; and
a clock generator having an input coupled to the output of the clock recoverer to receive the first clock signal, a reset input coupled to the synchronization signal, and an output providing the second clock signal based on the first clock signal and having a phase controlled as a function of the synchronization signal.

11. The apparatus according to claim 10, wherein the synchronization signal represents an event not embedded in the data.

12. The apparatus according to claim 10, wherein the synchronization signal is a start-of-frame indicator from the data.

13. The apparatus according to claim 10, wherein the clock generator is a frequency divider circuit.

14. The apparatus according to claim 10, wherein the clock generator is a modulo N counter.

15. The apparatus according to claim 10, configured to operate in an optical network terminal.

16. The optical network terminal according to claim 15, wherein the second clock signal is used for transmitting a bus carrying data from the optical network terminal to an optical line terminal.

17. The optical network terminal according to claim 16, wherein transmission of busses carrying data between the optical line terminal and an optical network terminal is transmitted through an optical distribution network.

18. The optical network terminal according to claim 17, wherein the optical distribution network includes at least one optical splitter.

19. The optical network terminal according to claim 16, further including a transceiver configured to transmit the bus carrying data from an optical network terminal to the optical line terminal in Ethernet frame units.

20. The optical network according to claim 16, further including a transceiver configured to transmit the bus carrying data from an optical network terminal to the optical line terminal in ATM cells.

21. The optical network terminal according to claim 16, further including a transceiver configured to transmit the bus carrying data from an optical network terminal to the optical line terminal using a TDMA protocol.

22. A method of controlling a phase of a clock signal, comprising:
determining a variable bit delay of a second clock signal relative to a first clock signal, the first clock signal being frequency locked; and
delaying the second clock signal by the variable bit delay to control a phase of the second clock signal.

23. The method according to claim 22, wherein the variable bit delay is determined by sampling the second clock signal at a frequency of the first clock signal.

24. The method according to claim 22, wherein the variable bit delay is determined by measuring a difference between a frequency of the second clock signal and the frequency of the first clock signal and calculating the variable bit delay.

25. The method according to claim 22, wherein a second clock signal frequency is a non-integer multiple of a first clock signal frequency.

26. An apparatus for controlling a phase of a clock signal, comprising:
a clock recoverer including an input coupled to a bus carrying data and an output providing a first clock signal recovered from the data;
a variable bit delay generator to determine a variable bit delay of a second clock signal relative to a first clock signal, the first clock signal being frequency locked; and
a variable shift register to delay the second clock signal by the variable bit delay to control a phase of the second clock signal.

27. The apparatus according to claim 26, wherein the variable bit delay generator samples the second clock signal at a first clock signal frequency to determine the variable bit delay.

28. The apparatus according to claim 26, wherein the variable bit delay generator measures a difference between a second clock signal frequency and a first clock signal frequency to determine the variable bit delay.

29. The apparatus according to claim 26, configured to operate in an optical network terminal.
